(19) United States
(12) Patent Application Publication
(10) Pub. No.: US 2004/0262463 A1
(43) Pub. Date: Dec. 30, 2004

(54) Adjustable support device for a feeding tube

(76) Inventor: Mark Jackson, Louisa, KY (US)

Correspondence Address: ROBERT R. WATERS, ESQ., WATERS LAW OFFICE, PLLC, 633 SEVENTH STREET, HUNTINGTON, WV, 25701, US

(21) Appl. No.: 10/607,453

(22) Filed: Jun. 26, 2003

(51) Int. Cl. F16L 3/00

(52) U.S. Cl. 248/121

(57) ABSTRACT

The invention is an apparatus for supporting a feeding tube used to deliver a processed food product to a gastronomy patient. The device is adjustable and designed to be operated by the patient using one hand and adapted for use in a chair or automobile. The device consists of a support base which maybe curved or padded for particular utility. The apparatus is further comprised of a mast which if pivotally attached to the base along with a retaining member which is movably attached to the mass at a point between the two ends of the mast. The retaining member is particularly adapted to support and hold a feeding tube.

### FIELD OF THE INVENTION

This invention relates to a portable adjustable feeding tube support structure for anchoring a feeding tube during use in feeding an individual with a gastronomy tube.

### BACKGROUND OF THE INVENTION

The use of a gastronomy tube may be required in situations where injuries or gastro-intestinal difficulties preclude an individual from taking food orally. These situations include severe mouth or neck trauma, stroke or paralysis, throat cancer, and many other conditions. In some cases, the use of a gastronomy tube may be temporary while other conditions may require long-term or permanent use. To accomplish food intake by means of a gastronomy tube, a surgical opening is made in the patient's stomach and a permanent gastronomy tube is inserted therein. The gastronomy hose is permanently anchored to the patient's mid-section usually by means of an elastic belt that the patient wears to secure the tube and prevent it from getting caught on clothing. The gastronomy tube includes an appropriate closure means to close the tube between times of feeding.

A gastronomy patient receives nourishment through a liquid food product that is delivered through the gastronomy tube. In order to receive the food product, a feeding tube assembly is used, and the feeding tube assembly includes a hose appropriately sized to couple with the gastronomy tube opening in the patient. In general, the feeding tube is a vertical column somewhat similar to a funnel, into which the processed food product is poured. The food product exits the feeding tube through a flexible hose in the bottom and is gravity fed to the patient through the coupler on the gastronomy tube. In practice, the feeding tube is oriented at a higher elevation than the patient's stomach such that gravity will more effectively cause the food product to be delivered.

### DESCRIPTION OF RELATED ART

A review of the prior patent art shows a number of patents directed to assisting devices for anchoring the gastronomy tube to the individual or devices that address related issues. Those patents include U.S. Pat. No. 5,147,322 to Bowen et al., for “Medical Appliance Securing Device”. In addition, U.S. Pat. No. 5,738,661 by Larice is a medical device for holding a feeding tube. The device provides a substantially rigid fastening of a feeding tube to the patient. The device includes a drainage bag disposed about the tube for containing any drainage that may occur through the body opening of which the tube is inserted. The drainage bag may be provided with a feeding tube engaging or capable of accommodating feeding tubes of various diameters.

U.S. Pat. No. 5,895,373 by Hirsch et al., is a feeding tube retaining member filling tool. The patent includes a method for placing an external feeding tube in the gastro-intestinal tract of a patient. The claimed device includes a filling tool for filling a retaining member. The tool includes a fluid reservoir constructed to contain the fluid and a defined fluid flow path. The filling tool further includes a cannula constructed to connect to the filling lumen of the feeding tube. U.S. Pat. No. 5,702,371 by Bierman discloses an anchoring device to secure a catheter or other fluid supply tube to a patient's body. The anchoring system includes a flexible adhesive anchor pad which supports the retainer and, in one embodiment, the tube fitting includes two generally tubular parallel segments in, or connected by, a transverse member. The channels are sized to receive the tube fitting.

Since the use of a feeding tube may be permanent or long term, it is important that the process be simplified such that a patient is able to feed himself or herself independently. However, since feeding tube use affects a narrow segment of the overall population, little emphasis has been placed on feeding tube structural components. A means to hold or anchor the feeding tube while the food product is place therein is essential to an independent feeding operation by the patient. Furthermore, in order to provide a truly effective method, the user should be able to operate and load the feeding tube with food product using only one hand. One handed use is essential, for example, when a feeding tube is needed for a baby. In such a situation, the mother will need to hold the baby with one arm and will only have one hand available for loading and holding the feeding tube.

U.S. Pat. No. 5,386,958 by Amato is directed to the issue of holding a feeding tube during use, although the device is severely limited in many respects. Amato is comprised essentially of a broad, flat, horizontal base with a vertical support leg pivotally attached to the base. At the opposite end of the vertical support leg, a horizontal support member is hingeably attached. That support member includes an opening at the end, through which a feeding tube is inserted. The opening is sized to receive the feeding tube and hold the same in place. The feeding tube, therefore, may be supported by the Amato device which is generally designed to be placed on a table top. Once the feeding tube and hose are assembled in place, a patient will be able to pour the food product into the feeding tube as desired. Although Amato may be useful for many gastronomy patients, the device is inadequate for an individual that only has the use of one hand. This is because two hands will be required in order to assemble the feeding tube, feeding hose, and support stand. Amato does not provide for a means of anchoring the feeding tube such that when the hose is inserted from the bottom, it will remain in place. Accordingly, two hands are needed to assemble the components initially. In addition, although Amato features a hinged member that may be folded down for storage or removal, the Amato device does not feature a method of adjusting the position of the vertical member to orient it closer to or away from the user.

A serious drawback to the Amato device is that the base and design of the structural components are such that the device may only effectively be used while placed on a table top. For gastronomy patients, this is highly disadvantageous. This is because it is important to minimize the length of the hose to the patient's stomach. In order for the gravity flow to be effective, the hose must be minimized. Otherwise, when a large amount of food product is hanging in place in a long flexible hose, it becomes harder for gravity to move the food product on into the patient's stomach. As such, it would be highly advantageous to move the feeding tube support structure into the chair of the patient such that it can be closer to the patient's abdomen, thereby minimizing hose length.

It is also very important that a feeding tube support structure be designed which will facilitate its use by a patient when traveling or away from home. Furthermore, the device should be versatile enough to be used in a seated position or upon a table top, and the device should be versatile enough to be used in conjunction with a wide assortment of seats.

The present invention is designed to address those limitations precisely as a feeding support apparatus is disclosed which may be operated through the use of a single hand and which may be used in a wide assortment of situations.

### SUMMARY OF THE INVENTION

The present invention is directed to a feeding tube support structure to enable the user to feed himself or herself independently, and using only one hand. The structure features a versatile and portable base which may be placed flat on a table top or placed on an incline such as during use of the feeding tube holder in a chair. The apparatus includes a support mast which may be orientated at an angle between 0° and 90° while maintaining stability and holding a feeding tube with processed food product therein. The apparatus includes a clamping member for supporting a feeding tube, and such clamping member may be adjusted higher or lower on the support mast. The clamping member can be manipulated with only one hand. The support mast and clamping means feature multiple fields of movement, resulting in a highly versatile structure.

One of the primary objectives of the present invention is to create a feeding tube support structure for effectively anchoring and supporting a feeding tube for a gastronomy feeding operation.

Another objective of the present invention is to create a feeding tube support structure that may be placed in the chair of the user during its operation. Furthermore, the present invention may be used in a wide assortment of chairs including couches and chairs featuring curved seats.

Another objective of the present invention is to create a feeding tube support structure wherein the feeding tube may be adjusted vertically with respect to the base using a single hand.

Another objective of the present invention is to create a feeding tube support structure featuring multiple fields of adjustment for stable three dimensional movement of the feeding tube for the convenience of the user.

Another objective of the present invention is to create a feeding tube support structure that accommodates single handed use. Accordingly, the present invention may be easily adjusted vertically or in any other field of movement by the user using only one hand. This feature has particular utility for those individuals that suffer from a hand or arm injury, and is also particularly useful in the administering of a feeding tube process to an infant or small child.

Another objective of the present invention is to create a feeding tube support structure that minimizes the length of the flexible tube extending between the feeding tube funnel portion and the gastronomy opening in order to minimize waste, and in order to optimize the gravity feeding process.

Another objective of the present invention is to create a feeding tube support structure that is easy to construct, thereby minimizing production cost.

Another objective of the present invention is to create a feeding tube support structure that is convenient to be used inside an automobile.

As discussed above, the feeding tube support structure of the present invention overcomes the disadvantages inherent in prior art methods and prior art devices or support structures for a feeding tube. In this respect, before explaining at least one embodiment of the invention in detail, it is to be understood that the invention is not limited in its application to the details of construction and/or to the arrangement of the support structure set forth in the following description or illustrated in the drawings. The invention is capable of other embodiments and of being practiced and carried out in various and diverse ways. Also, it is to be understood that the phraseology and terminology employed herein are for the purposes of description and should not be regarded as limiting.

Accordingly, those skilled in the art will appreciate that the concept upon which this invention is based may readily be utilized as a basis for the design of other structures, methods, and systems for carrying out the purposes of the present invention. It is important, therefore, that the claims be regarded as including such equivalent constructions insofar as they do depart from the spirit and scope of the present invention.

Furthermore, the purpose of the foregoing Abstract is to enable the U.S. Patent and Trademark Office and the public generally, and especially including the practitioners of the art who are not familiar with patent or legal terms or phraseology, to determine quickly from a cursory inspection, the nature and essence of the technical disclosure of the application. The Abstract is neither intended to define the invention of the application, nor is it intended to be limiting to the scope of the invention in any respect.

### BRIEF DESCRIPTION OF THE DRAWINGS

Additional utility and features of this invention will become more fully apparent to those skilled in the art by reference to the following drawings, wherein the feeding tube support structure of the present invention is described more fully:

FIG. 1 is a perspective view of the preferred embodiment of the present invention.

FIG. 2 is a close-up perspective view showing the anchoring of the mast with respect to the base and bracket of the preferred embodiment.

FIG. 3 is a perspective view of the preferred embodiment with dotted lines indicating the vertical field of movement of the mast.

FIG. 4 is an alternative embodiment of the present invention showing the utilization of a sliding bracket for lateral movement along the base with dotted lines indicating range of movement.

FIG. 5 is a side view of an alternative embodiment of the present invention showing the anchoring of bracket 12 with respect to base 10 wherein the bracket may be rotated about a central axis.

FIG. 6 is a side elevation view of the top portion of the mast of the preferred embodiment.

### DETAILED DESCRIPTION OF THE PREFERRED EMBODIMENT

The feeding tube support structure of the present invention may be constructed of a variety of materials and may take a variety of forms. The preferred embodiments discussed herein have particular utility both in achieving the purposes outlined above, as well as being durable, economical and easy to produce.

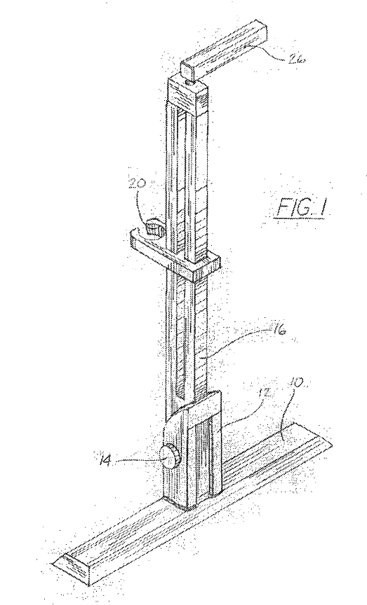

Referring to FIG. 1, the feeding tube support apparatus is comprised of a base 10 as shown. The base member 10 is generally flat on the bottom surface and may be constructed of a variety of materials including wood, lightweight metals such as aluminum, or preferably, plastic. In general, base 10 serves the purpose of providing stability for the feeding tube support structure and preventing the device from tipping over during use. In addition, the base 10 also features an extended portion on each end whereby the device may be placed under the legs of the user or in the seat of the user. In practice, if the user is sitting on the support structure base 10 or one side of base 10, the structure will be completely stable and will also be naturally oriented in close proximity to the abdominal area of the user. As stated above, minimizing the length of the supply line from the feeding tube to the gastronomy opening in the user's stomach is a key objective of the present invention.

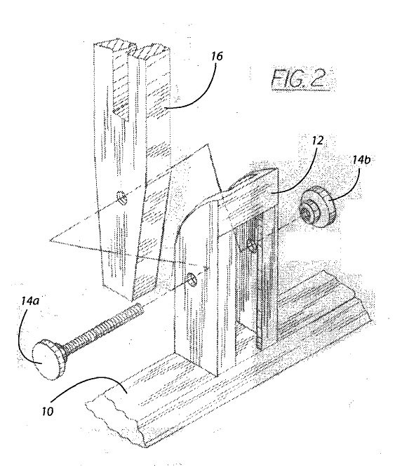

As shown in FIG. 1, base 10 includes, in this embodiment, a central anchoring bracket 12 which is used to support and anchor the mast 16 of the present invention. Central anchoring bracket 12 is integrally formed with base 10 in this embodiment. As shown, bracket 12 includes an open central region wherein the mast 16 is disposed. A bolt assembly 14 or suitable substitute is mounted as shown in FIG. 1, serving the purpose of holding mast 16 to base 10. As further shown in the drawing, mast 16 is pivotally connected at the location of anchoring bracket 12 utilizing bolt assembly 14. Due to the pivotal arrangement, mast 16 may be oriented vertically as shown in FIG. 1, or it may be moved forward by pivoting with respect to bolt assembly 14 on support bracket 12. The anchoring of the mast 16 to support bracket 12 is more fully shown and demonstrated in FIG. 2. As further shown in FIG. 2, the bolt assembly consists of bolt 14a and nut 14b. Preferably, the nut and bolt are constructed such that they may be tightened or loosened by hand in order to obtain the correct tension such that the mast may be moved, yet will be stable at any location.

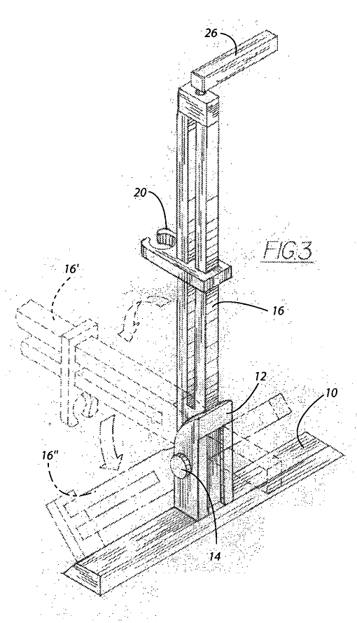

As shown in FIG. 3, mast 16 may pivot forward to change the location of the feeding tube. The mast location may be varied approximately 135° in this embodiment although it will generally not be practical to lower the mast below the level of the base. Mast 16 may be constructed of a variety of materials including wood, lightweight metals or plastic. In order to minimize total weight of the structure while also enabling the economic construction of the apparatus, plastic is preferable. Mast 16 features, in this preferred embodiment, an open central region. The mast 16 itself may be integrally formed of one plastic member by an appropriate injection molding or other plastic molding procedure. In the alternative, mast 16 may be constructed of two separate longitudinally extensive mast members spaced in parallel about an open center. In this arrangement, an upper and lower end cap are necessary to fully comprise mast 16.

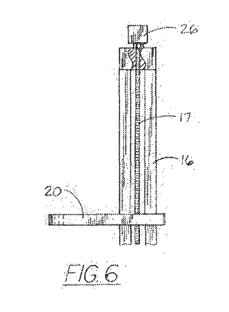

As shown in FIG. 6, mast assembly 16 includes a single section of a fully threaded rod 17. Rod 17 is constructed of any appropriate metal or possibly plastic and the thread density and orientation may vary. The mast 16 assembly may further include handle 26 which is connected to one end of said fully-threaded rod 17 as shown.

In use, the actual holding of the feeding tube funnel is achieved by support member 20. In the assembly, support member 20 is formed with appropriate apertures within which the longitudinally extensive portions of mast 16 are inserted. Support member 20 further includes a central threaded aperture within which said threaded rod 17 passes. Upon full assembly, the orientation of the threads is such that as handle 26 is turned, threaded rod 17 will turn and accordingly, support member 20 will either raise or lower with respect to the base, depending upon which direction the handle is turned. The second end of support member 20 may feature a clamping member, or other such suitable device for strongly anchoring the feeding tube funnel such that it is stable and fixed. Accordingly, the opening in the second end of support member 20 may include teeth, or tabs such as to provide a strong frictional bond with the feeding tube funnel in order to hold it in place.

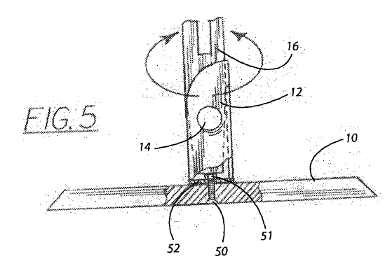

Another embodiment of the invention is shown in FIG. 5. The feeding tube support apparatus in FIG. 5 is similar in most respects to the apparatus of FIG. 1 with one key exception. In this embodiment, bracket 12 is separate and distinct from base 10 rather than integrally formed. Bracket 12 is rotatably anchored to base 10 about a central connecting means in the center of the bracket. For example, bracket 12 may feature a threaded bolt 50 which penetrates the bottom plate 52 of bracket 12. Bolt 50 is anchored by nut 51 which is tight enough to secure the base but loose enough to provide rotation of bracket 50 upon application of force by the user to turn the bracket 12. In such a construction, the head of bolt 50 would be countersunk in the bottom of base 10 such that base 10 would still feature a smooth support surface along the bottom side.

In operation, the entire bracket 12 may be rotated 360° about a central axis perpendicular to the surface of base 10. As such, the feeding tube support structure is now capable of three dimensional movement since the mast may be raised or lowered in a two dimensional fashion while the entire mast assembly may be rotated about an axis. This arrangement features great flexibility in design in order to make the feeding tube experience as user friendly as possible.

The invention is also capable of a variety of comfort related options as well as aesthetic options. For example, base 10 may include padded material on the top surface of base 10 in order to be more comfortable when the user is sitting on one or both ends of base 10. Furthermore, the top surface of base 10 may be concave, featuring recessed areas corresponding to the legs of the user. This will enable the device to be even more steady.

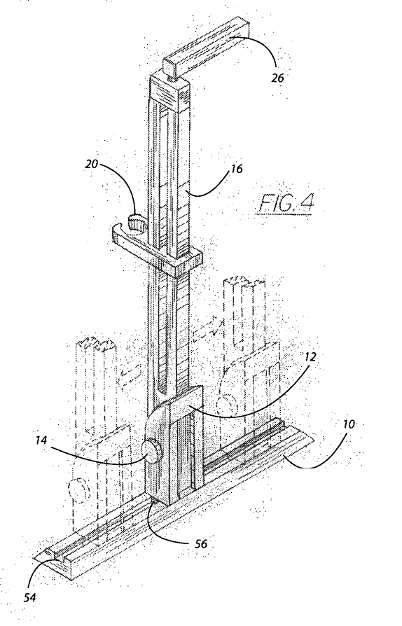

In yet another alternative construction option, base 10 may feature a slotted groove 54 running along at least a portion of the length of base 10. FIG. 4 demonstrates the structure of this embodiment. As shown, bracket 12 may be constructed with a male tab portion 56 integrated within the bottom of bracket 12 such that it may be frictionally moved within the groove 54 of modified base 10, once again providing three dimensional movement of the apparatus in order to aid a user in a fast and convenient feeding tube experience. FIG. 4 further shows how the bracket 12 and mast 16 may be laterally moved, for example, to positions a and b.

1. An apparatus for supporting a feeding tube, comprising:
a) a base having a top surface and a bottom surface, and having a first end and a second end, said second end spaced apart from said first end;
b) a mast consisting of a first end and a second end, wherein said first end of said mast is pivotally attached to said base; and
c) a retaining member consisting of a first end and a second end wherein said first end of said retaining member is moveably attached to said mast at a point between said first end of said mast and said second end of said mast, and wherein said second end of said retaining member is adapted to support and hold a feeding tube.

2. The apparatus of claim 1 wherein said apparatus is further defined to include a means for moving the location of said retaining member with respect to said base by changing the location at which said retaining member attaches to said mast.

3. The apparatus of claim 2 wherein said mast includes a series of discrete anchoring locations along said mast wherein said anchoring locations are comprised of apertures for receiving a corresponding peg or pin located on said retaining member for removably anchoring said retaining member at each of said discrete anchoring locations.

4. The apparatus of claim 1 wherein said apparatus is further defined to include a means for moving said retaining member along said mast, thereby raising or lowering said retaining member with respect to said base.

5. The apparatus of claim 1 wherein said mast may be fixedly pivoted such that the angle of incidence between said base and said mast may be adjusted between 0 degrees and 180 degrees.

6. The apparatus of claim 1 wherein said top surface of said base is padded.

7. The apparatus of claim 1 wherein said top surface of said base features one or two curved recesses such that when the base is placed under the legs of the user of said apparatus and the user is sitting on said base, the legs of the user will rest comfortably within said curved recess or recesses to assist in comfortably securing the base.

8. The apparatus of claim 1 wherein said base is further adapted to include a removable mounting means whereby said base may be fixedly but removably secured to a horizontal surface such as a table top.

9. The apparatus of claim 1 wherein said mast consists of a pair of first and second end caps, a first and second longitudinally extensive riser, and a threaded rod such that said rod is maintained in a fixed parallel position between said first and second longitudinally extensive risers with said risers and rod terminating at said first end at said first end cap and at said second end at said second end cap.

10. The apparatus of claim 1 wherein said mast is comprised of a fixed longitudinally extensive riser including a center recess and wherein a threaded rod is oriented within the center recess in parallel to the edge of said riser.

11. The apparatus of claim 1 wherein said retaining member is further characterized to include an anchoring means on said second end such that said anchoring means may be used to clamp a feeding tube during use.

12. The apparatus of claim 11 wherein said anchoring means provides adequate support for said feeding tube such that it is held tightly fixed despite the application of pressure from the bottom in the attachment of a flexible hose in the bottom of said feeding tube.

13. The apparatus of claim 10 wherein said retaining member is anchored to said threaded rod in such a way that said retaining member may be moved along said mast by turning of said threaded rod.

14. The apparatus of claim 13 wherein said apparatus is adapted to include a handle for turning said threaded rod.

15. An apparatus for supporting a feeding tube, comprising:
a) a base having a top surface and a bottom surface, and having a first end and a second end, said second end spaced apart from said first end;
b) a bracket rotatably mounted upon said base;
c) a mast consisting of a first end and a second end, wherein said first end of said mast is pivotally attached to said bracket; and
d) a retaining member consisting of a first end and a second end wherein said first end of said retaining member is moveably attached to said mast at a point between said first end of said mast and said second end of said mast, and wherein said second end of said retaining member is adapted to support and hold a feeding tube.

16. The apparatus of claim 15 wherein said apparatus is further defined to include a means for moving the location of said retaining member with respect to said base by changing the location at which said retaining member attaches to said mast.

17. The apparatus of claim 15 wherein said apparatus is further defined to include a means for moving said retaining member along said mast, thereby raising or lowering said retaining member with respect to said base.

18. The apparatus of claim 15 wherein said mast may be fixedly pivoted such that the angle of incidence between said base and said mast may be adjusted between 0 degrees and 180 degrees.

19. The apparatus of claim 15 wherein said top surface of said base is padded.

20. The apparatus of claim 15 wherein said top surface of said base features one or two curved recesses such that when the base is placed under the legs of the user of said apparatus and the user is sitting on said base, the legs of the user will rest comfortably within said curved recess or recesses to assist in comfortably securing the base.

21. The apparatus of claim 15 wherein said base is further adapted to include a removable mounting means whereby said base may be fixedly but removably secured to a horizontal surface such as a table top.

22. The apparatus of claim 15 wherein said mast consists of a pair of first and second end caps, a first and second longitudinally extensive riser, and a threaded rod such that said rod is maintained in a fixed parallel position between said first and second longitudinally extensive risers with said risers and rod terminating at said first end at said first end cap and at said second end at said second end cap.

23. The apparatus of claim 15 wherein said mast is comprised of a fixed longitudinally extensive riser including a center recess and wherein a threaded rod is oriented within the center recess in parallel to said edge of said riser.

24. The apparatus of claim 15 wherein said retaining member is further characterized to include an anchoring means on said second end such that said anchoring means may be used to secure a feeding tube during use.

25. The apparatus of claim 24 wherein said anchoring means provides adequate support for said feeding tube such that it is held tightly fixed despite the application of pressure from the bottom in the attachment of a flexible hose in the bottom of said feeding tube.

26. The apparatus of claim 23 wherein said retaining member is anchored to said threaded rod in such a way that said retaining member may be moved along said mast by turning of said threaded rod.

27. The apparatus of claim 26 wherein said apparatus is adapted to include a handle for turning said threaded rod.

28. The apparatus of claim 15 wherein said base includes a slotted aperture wherein said rotatably mounted bracket may be moved laterally toward one end or the other of said base.
